(19) United States
(12) Patent Application Publication
(10) Pub. No.: US 2006/0088657 A1
(43) Pub. Date: Apr. 27, 2006

(54) Electrical cable having a surface with reduced coefficient of friction

(76) Inventors: David Reece, Carrollton, GA (US); Randy D. Kummer, Villa Rica, GA (US); Mark D. Dixon, Carrollton, GA (US); John R. Carlson, Newnan, GA (US); Hai Lam, Douglasville, GA (US); Philip Sasse, Douglasville, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/120,395

(22) Filed: May 3, 2005

Related U.S. Application Data
(63) Continuation-in-part of application No. 10/952,048, filed on Sep. 28, 2004.
(60) Provisional application No. 60/587,584.

(51) Int. Cl. B05D 5/12

(52) U.S. Cl. 427/117

(57) ABSTRACT

The present invention includes a cable having reduced surface friction and the method of manufacture thereof including steps in which a conductor wire is coated with a first plastic material, coated with a second plastic material and the coated conductor wire then cooled, and includes a step in which a lubricating material is applied to the surface of the cooled, coated cable. The cable includes at least one conductor core and at least one coating of plastic material and incorporates a lubricating material on the exterior coating. The equipment for the manufacturing of the electrical cable includes a reel for supplying a conductor wire to an extruding head, which is connected to tanks containing plastic materials for coating the conducting wire, a reel for taking up the cable, and a device for the application of a lubricating material onto the surface of the cable.

This application claims the benefit of priority of Provisional U.S. Pat. Application No. 60/587,584 filed Jul. 13, 2004, and U.S. patent application Ser. No. 10/952,048, filed Sep. 28, 2004 which are herein incorporated by reference.

The present invention relates to an electrical cable and to a method of and equipment for reducing its coefficient of friction.

### BACKGROUND OF THE INVENTION

Electrical cables which include at least one conductor core and at least one coating are well known.

Such cables present the disadvantage that their exterior surface has a high coefficient of friction, so that they are awkward to fit in internal sections of walls and ceilings or conduits, since when they come into contact with the surfaces they become stuck or difficult to pull, etc.

In order to overcome said difficulty, alternative materials such as vaselines and the like have been used to coat the exterior surface of the cable, thereby reducing the coefficient of friction.

In a complementary manner, guides of small diameter are sometimes used, one end of which is inserted through the cavity through which the cable has to pass and the other is attached to the end of the cable which must be inserted into the cavity. Thus, once the guide has emerged at the desired place it is pulled until the end of the cable appears again after having passed through the entire section.

In numerous fields of application, and in particular telecommunications, electric or fiber optic cables are inserted into ducts. There is therefore a need to minimize the coefficient of friction between cables and the inside walls of ducts.

In one solution, the core of the cable passes via a first extruder which applies a conventional sheath thereto i.e., a jacket and/or insulation, often made of polyethylene. The sheathed core then passes through a second extruder which applies a lubricant layer thereto, such as an alloy of silicone resin and polyethylene. The cable lubricated in that way then passes in conventional manner through a cooling vessel.

A second solution provides for an extruder to cover the core of a cable with a sheath. At the outlet from that extruder there is disposed a coating chamber for applying granules of material to the still-hot sheath, which granules are designed to become detached when the cable is inserted in a duct. Finally, the coated cable passes through a cooling vessel.

In both of these two prior solutions, it is necessary to interpose additional equipment between the extruder and the cooling vessel. That gives rise to a major alteration of the manufacturing line.

In addition, the equipment for depositing the lubricant must be very close to the sheath extrusion head since otherwise it is not possible to control the thickness of the sheath properly. In any event, the additional equipment occupies non-negligible space and such an arrangement is not favorable for control over the dimensions of the sheath.

Whatever the prior art method used, the manufacture and/or installation of said cables involves a considerable loss of time and an economic cost, since alternative materials are required.

### OBJECTS AND SUMMARY OF THE INVENTION

The present invention thus seeks to provide a method for making a lubricated cable that does not significantly alter the geometrical characteristics of the cable.

The invention thus provides apparatus for depositing a lubricant coating on a cable, the cable having a sheath made by means of an extruder followed by a cooling vessel. Alternatively, downstream from said cooling vessel, the apparatus may comprise a preparatory treatment member followed by a deposition chamber provided with a lubricant material. This preparatory treatment member can be a heater member or it can perform treatment by the corona effect on the sheath of the cable.

In one embodiment of the present invention, the lubricant material is deposited in a bath.

In another embodiment of the invention, the lubricant material is deposited by spraying an emulsion or by spraying using a gas.

In a further embodiment of the invention, the lubricant material is deposited by means of a calibrated die.

In yet another embodiment of the invention, the lubricant material is deposited by plasma phase spraying.

The invention also provides a method of using the apparatus, the method including a step of heating the cable sheath and a step of depositing a lubricant material on said sheath.

### DESCRIPTION OF THE INVENTION

With the method, the cable and the equipment of the invention said disadvantages can be solved, while providing other advantages which will be described below.

The method for the manufacture of electrical cables is characterized in that it includes a step in which a lubricating material is applied to the surface of the cable.

A cable with low coefficient of friction is achieved thereby, so that subsequent installation of the same is considerably simplified, since it slides over the surfaces with which it comes into contact.

According to one characteristic of the invention, the spraying step is carried out between the step of coating the conductor wire with plastic material and the step of cooling said material

This position of the spraying step in time is important since, when the conductor wire is coated with the plastic material, said material is in a state of fusion, the high temperature of which causes volatilization of the solvents present in the lubricating material, which means that there is greater adherence of said lubricating material on the surface of the plastic material. The subsequent cooling of the plastic material together with the lubricating material leads to drying on the surface, leaving the two materials bonded to form a coating of low coefficient of friction.

Advantageously, the lubricant material is selected from the group consisting essentially of fatty amides, hydrocarbon oils, fluorinated organic resins, and mixtures thereof. In one embodiment of the apparatus, the lubricant material is deposited in a bath. In another embodiment of the apparatus, the lubricant material is deposited by spraying an emulsion or by spraying using a gas. In yet another embodiment of the apparatus, the lubricant material is deposited by means of a calibrated die. In another embodiment of the apparatus, the lubricant material is deposited by means of dipping the cable in the lubricant. In another embodiment of the present invention micro-spheres or beads reduce the contact area and/or a bead or sphere encapsulates a lubricant and the beads or spheres are applied to the surface of the plastic material. In a further embodiment of the apparatus, the lubricant material is deposited by plasma phase spraying. The present invention further includes as application means saturated wipe, chemical vapor deposition, drip and wipe, sponge wipe, and the like. The lubricant material may be applied at any point in the manufacturing process after formulation of the sheath, and depending upon the material, may be heated prior to application to the sheath.

Advantageous fatty amides and metallic fatty acids include, but are not limited to erucamide, oleamide, oleyl palmitamide, stearyl stearamide, stearamide, behenamide, ethylene bisstearamide, ethylene bisoleamide, stearyl erucamide, erucyl stearamide, and the like. Advantageous hydrocarbon oils include, but are not limited to, mineral oil, silicone oil, and the like. Lubricating materials suitable for the present invention further include plasticizers, dibasic esters, silicones, anti-static amines, organic amines, ethanolamides, mono-and di-glyceride fatty amines, ethoxylated fatty amines, fatty acids, zinc stearate, stearic acids, palmitic acids, calcium stearate, lead stearate, sulfates such as zinc sulfate, etc., and the like. The above lubricating materials may be used individually or in combination.

The electric cable is characterized in that it incorporates a lubricating material on the exterior coating, which lubricating material may be applied by known means such as spraying, dipping, by means of a bath, etc. If desired the exterior coating of the cable may be somewhat porous, thereby resulting in lubricating material residing in the pores.

The exterior coating on the cable is thus well covered with said material, forming a fine layer on the plastic material, since it emerges at high pressure and the plastic material is at high temperatures.

The equipment for the manufacturing of electrical cables is characterized in that it includes a device for the application of a lubricating material on the surface of the cable.

Said device may be a box section through which the cable passes, a plurality of nozzles for spraying the lubricating material mounted inside the box section, a tank for said lubricating material, and a pressure pump to carry the lubricating material from the tank to the spraying nozzles.

Moreover, the device also includes a pressure adjusting valve, a level indicator of the lubricating material tank, and a pressure gauge.

For a better understanding of the present invention, drawings are attached in which, schematically and by way of example, an embodiment is shown.

In said drawing,

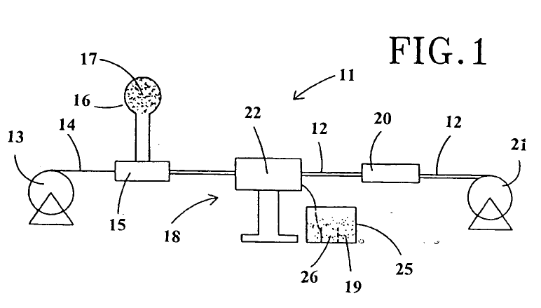

FIG. 1 is a schematic elevation view of equipment for manufacturing electrical cable, according to the method of the present invention; and

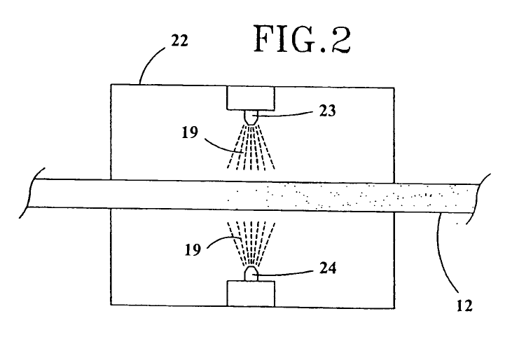

FIG. 2 is a schematic plan view of a device for the application of lubricating material onto the surface of the cable.

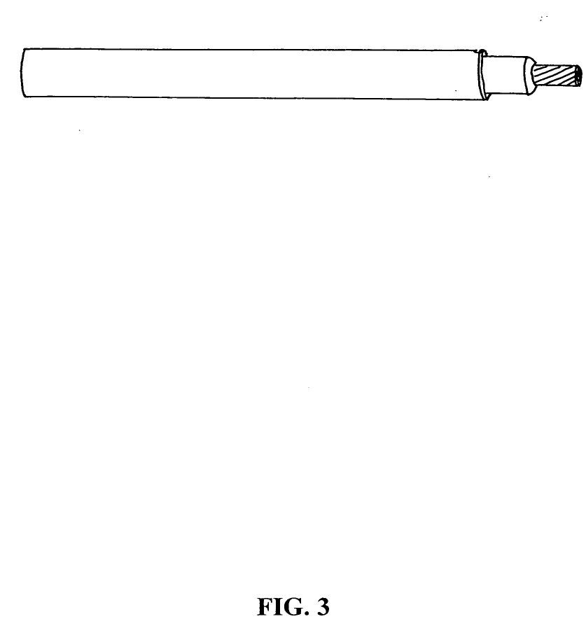

FIG. 3 is a section view of a THHN cable of the present invention.

### DESCRIPTION OF A PREFERRED EMBODIMENT

THHN or THWN-2 conductors are 600 volt copper conductors with a thermoplastic insulation/nylon sheath and are heat, moisture, oil, and gasoline resistant. AWG sizes usually range from 14 through 6. THHN conductors are primarily used in conduit and cable trays for services, feeders, and branch circuits in commercial or industrial applications as specified in the National Electrical Code. Type THHN is suitable for use in dry locations at temperatures not to exceed 90° C. Type THWN-2 is suitable for use in wet or dry locations at temperatures not to exceed 90° C. or not to exceed 75° C. when exposed to oil or coolant. Type MTW is suitable for use in wet locations or when exposed to oil or coolant at temperatures not to exceed 60° C. or dry locations at temperatures not to exceed 90° C. Type THHN, THWN-2, and MTW copper conductors are usually annealed (soft) copper, insulated with a tough, heat and moisture resistant polyvinylchloride (PVC), over which a nylon (polyamide) or UL-listed equivalent jacket is applied.

As can be appreciated in the figures, the equipment 11 for manufacturing electrical cable 12 of the present invention includes a reel 13 which supplies conductor wire 14 to an extruding head 15, which in turn includes a tank 16 of second plastic material 17; a device 18 for the application of the lubricating material 19 by applying onto the exterior surface of the cable; a cooling box 20 for cooling the exterior surface of plastic material 17 which is in a state of semi-fusion on the conductor wire 14; and a reel 21 for taking up the resulting cable 12. Advantageously the conductor wire is coated with a first plastic material and this in turn is coated with the second plastic material to which the lubricating material is applied.

As can also be seen in the figures, the tank 18 for the application of the lubricating material 19 onto the surface of the cable 12 may include a box section 22 through which the cable 12 passes; in one embodiment two nozzles 23, 24 are mounted inside the box section 22 for spraying the lubricating material 19; a tank 25 for storing said lubricating material 19; a pressure pump 26 for making the lubricating material 19 travel from the bank 25 to the spraying nozzles 23, 24; a valve (not shown) for adjusting the pressure at which the lubricating material 19 must emerge through the spraying nozzles 23, 24; an indicator (not shown) of the level of the tank 25 for the lubricating material 19; and a pressure gauge (not shown) to measure the pressure of the lubricating material.

The plastic materials include known materials used in electrical wire and cable products such as polyethylene, polypropylene, polyvinylchloride, organic polymeric thermosetting and thermoplastic resins and elastomers, polyolefins, copolymers, vinyls, olefin-vinyl copolymers, polyamides, acrylics, polyesters, fluorocarbons, and the like. Advantageously the THHN cable of the present invention has a layer of polyvinylchloride near or adjacent the conductor with an outer layer of polyamide, preferably nylon, or equivalent outer layer.

The present inventive method for the manufacture of electrical cable 12 includes a first step of coating conductor wire 14 is with plastic material 17; a second step of applying the lubricating material 19 onto the plastic coating material, forming a fine layer on the plastic material 17, taking advantage of said plastic material being still in state of semi-fusion in order to enhance adherence of the lubricating material 19 on said plastic material, since there may occur volatilization of any solvents which form part of the lubricating material; and a third step cooling the plastic material 17 together with cooling of the lubricating material 19, to provide an exterior coating of the cable 12 with a low coefficient of friction.

Cable 12 is thus obtained with at least one conducting core and an exterior coating, the main characteristic of which is that its coefficient of friction is low, which makes it easier to install since it slips on the surfaces with which it comes into contact.

Another beneficial property gained by the present invention is an increased resistance to “burn-through.” “Burn-through,” or “pull-by,” results from friction generated by pulling one cable over another during installation, causing deterioration and eventual destruction to its own jacket as well as the jacket of the other cable. When using a lubricated cable of this invention the number of six-inch-stroke cycles required to produce bum-through was increased from 100 to 300.

The present inventive cable may also enhance ease in stripping the jacket from the cable end—termed stripability.

A further benefit of the present invention is the reduction of jacket rippling. Jacket rippling results from the friction of the jacket against building materials, causing the jacket material to stretch and bunch. Jacket damage may result. Installation situations, which repeatedly caused jacket rippling in unlubricated cable caused no rippling in lubricated cable jackets.

Despite the fact that reference has been made to specific embodiments of the invention, it will be clear to experts in the subject that the cable, the method and the equipment described can be varied and modified in many ways, and that all the details mentioned can be replaced by others which are technically equivalent without departing from the sphere of protection defined by the attached claims.

For example, cable 12 on which the lubricating material 19 is applied can be of any desired configuration and can be an optical fiber cable or the like.

It has been found experimentally that the use of a lubricating material disclosed herein is suitable for providing a considerable reduction of the coefficient of friction of the cable, which means that it is easier to install without adding any external element to it, which is one of the objectives sought in the present invention.

### EXAMPLE

To understand the affects of the jacket lubricant system on the ease of pull variations of the UL (Underwriters Laboratories, Inc.) joist pull test was utilized.

The joist pull test outlined in UL 719 Section 23 establishes the integrity of the outer PVC jacket of Type NM-B constructions when subjected to pulling through angled holes drilled through wood blocks.

The test apparatus consists of an arrangement of 2″×4″ wood blocks having holes drilled at 15° drilled through the broad face. Four of these blocks are then secured into an frame so that the centerlines of the holes are offset 10″ to create tension in the specimen through the blocks. A coil of NM-B is placed into a cold-box and is conditioned at −20° C. for 24 hours. A section of the cable is fed through corresponding holes in the blocks where the end protruding out of the last block is pulled through at 45° to the horizontal. The cable is then cut off and two other specimens are pulled through from the coil in the cold-box. Specimens that do not exhibit torn or broken jackets and maintain conductor spacing as set fort in the Standard are said to comply.

[image]

Pulling wire through the wood blocks provides a more direct correlation of the amount of force required to pull NM-B in during installation. Because of this relationship, the joist-pull test is initially the basis for which ease of pulling is measured, but a test for quantifying this “ease” into quantifiable data had to be established.

A variable-speed device was introduced to pull the cable specimen through the blocks. An electro-mechanical scale was installed between the specimen and the pulling device to provide a readout of the amount of force in the specimen. To create back tension a mass of known weight (5-lbs) was tied to the end of the specimen.

Data recorded proved that NM-B constructions having surface lubricates reduced pulling forces.

A 12-V constant speed winch having a steel cable and turning sheave was employed; the turning sheave maintains a 45 degree pulling angle and provides a half-speed to slow the rate of the pulling so that more data points could be obtained. Holes were drilled in rafters whereby specimens could be pulled by the winch.

It was found using this method that lubricated specimens yielded approximately a 50% reduction in pulling force when compared to standard, non-lubricated NM-B specimens. The results are shown in Tables 1 and 2 wherein the data was recorded at five second intervals.

[image]

TABLE 1

| | Specimen Description | | | | | | | | |
|---|---|---|---|---|---|---|---|---|---|
| Test Pt. | Manufacturer | Manufacturer | Manufacturer | Manufacturer | Manufacturer | Manufacturer | Control | Control | Present |
| Descr. | A1 | A2 | A3 | B1 | B2 | B3 | 1 | 2 | Invention |
| 1st Point | 26.8 | 48.3 | | 37.8 | 37.4 | | 16.5 | 41.9 | 24 |
| 2nd Point | 34.6 | 51.1 | | 35.2 | 38.1 | | 41.6 | 42 | 20.5 |
| 3rd Point | 33.7 | 46.8 | | 32 | 33 | | 40.2 | 38.7 | 20 |
| 4th Point | 38.6 | 49.8 | | 34.7 | 34.6 | | 41.3 | 29.5 | 17.4 |
| 5th Point | 33.1 | 44.8 | | 34.2 | 32.5 | | 41.3 | 34.3 | 20.2 |
| 6th Point | 28.6 | 44.7 | | 32.2 | 33.2 | | 42.5 | 35.9 | 15.8 |
| 7th Point | 5.5 | 51 | | 32.2 | 33.9 | | 41.1 | 37 | 17.2 |
| 8th Point | 26.8 | 49.2 | | 33.9 | 33 | | 40.9 | 38.4 | 17.3 |
| 9th Point | 21.9 | 52.5 | | 32.6 | 30.6 | | 42.7 | 37.3 | 21.9 |
| Average | 30.51 | 48.69 | | 33.87 | 34.03 | | 41.45 | 37.22 | 19.37 |

AAA—Denotes Outlyers

Test in Table 1 performed at a constant speed with winch using ½ speed pulley

Test in Table 2 performed on cable with a 5# weight suspended at building entry
Std. Prod.
Average Surface Lube

37.6289 19.37

TABLE 2

| | Specimen Description | | | | | | |
|---|---|---|---|---|---|---|---|
| Test Pt. | Manufacturer A | Manufacturer B | Control 1 | Control 2 | Control 3 | Invention A | Invention B |
| Descr. | 14-2 | 14-2 | 14-2/12-2 | 14-2/12-2 | 14-2/12-2 | 14-2/12-2 | 14-2/12-2 |
| 1st Point | 34 | 32.6 | 50 | 47.5 | 40.2 | 21.5 | 12.3 |
| 2nd Point | 35 | 35.7 | 50.6 | 38.3 | 37.5 | 22.9 | 12.8 |
| 3rd Point | 35.5 | 31.2 | 46.7 | 43.2 | 27.5 | 29 | 12.1 |
| 4th Point | 37.7 | 35 | 44.5 | 46 | 36.8 | 22.4 | 14.9 |
| 5th Point | 40.5 | 30.6 | 46.2 | 39.5 | 36 | 23.3 | 11.9 |
| 6th Point | 32.9 | 28.8 | 40.9 | 35.7 | 41.2 | 21.1 | 12.5 |
| 7th Point | 44.2 | 32.4 | 52.8 | 37.5 | 37 | 21.6 | 11.7 |
| 8th Point | 43 | 32.4 | 40.7 | 27.7 | 31.7 | 22.5 | 11.7 |
| 9th Point | 43.4 | 30.5 | 40 | 31.1 | | 19.2 | 11 |
| 10th Point | 40 | | | | | | 11.6 |
| Average | 38.62 | 32.13 | 45.82 | 38.50 | 35.99 | 22.61 | 12.25 |

| | | |
|---|---|---|
| 14-2/12-2 | 14-2/12-2 | 14-2/12-2 |
| Control Avg. | Invention A | Invention B |
| 40.103241 | 22.61 | 12.25 |

TABLE 3
Pulling Data on THHN Cable

| Sample | Pulling Force, lbs |
|---|---|
| Control Cable | 38.5 |
| Cable + 0.25% additive A | 18.1 |
| Cable + 0.50% additive A | 16.0 |
| Cable + 0.85% additive A | 18.5 |
| Cable + 0.25% additive B | 13.2 |
| Cable + 0.50% additive B | 10.3 |
| Cable + 0.85% additive B | 9.6 |
| Cable + Yellow 77 lube | 15.3 |

[image]

What is claimed is:

1. A method for the manufacture of an electrical cable including:
providing an electrical conductor wire;
providing a first plastic material;
coating the conductor wire with the first plastic material;
providing a second plastic material;
coating the first plastic coated conductor wire with the second plastic material;
cooling the coated conductor wire; and
applying a lubricating material to the surface of the cooled, coated conductor wire.

2. The method according to claim 1, wherein the applying step is carried out between the step of coating the conductor wire with the second plastic material and the step of cooling the coated conductor wire.

3. The method according to claim 1, wherein the applying step is carried out after the coated conductor has cooled.

4. The method according to claim 1, wherein the lubricating material is selected from the group consisting essentially of fatty amides, hydrocarbon oils, plasticizers, silicone oils and mixtures thereof.

5. An electrical cable including at least one conductor core and at least one coating of plastic material having a lubricating material incorporated on the exterior coating of the plastic material.

6. The cable according to claim 1, wherein the lubricating material is applied by spraying.

7. An apparatus for the manufacture of an electrical cable including a reel for supplying a conductor wire to an extruding head, said extruding head connected to tanks containing at least two different plastic materials for coating the conducting wire, and a reel for taking up the cable, including a device for the application of a lubricating material onto the surface of the coated cable.

8. The apparatus according to claim 7, wherein the device for application of lubricating material on the surface of the cable includes an at least partly enclosed section through which the cable passes, a plurality of nozzles for spraying the lubricating material mounted inside said section, a tank for the lubricating material, and a pressure pump to carry the lubricating material from the tank to the spraying nozzles.

9. An apparatus according to claim 8, wherein the device for the application of the lubricating material onto the surface of the cable includes a pressure adjusting valve, a level indicator of the lubricating material in the tank, and a pressure gauge.

10. A method for manufacturing an electrical cable, comprising:
providing an electrical conductor wire;
providing a first plastic material;
coating the conductor wire with the first plastic material;
providing a second plastic material;
coating the first plastic coated conductor wire with the second plastic material;
applying a lubricating material onto the second plastic material, the second plastic material having a temperature of at least 85° C.; and
cooling the second plastic material after the lubricating material is applied thereon.

11. The method of claim 10, wherein during the coating step, the second plastic material has a temperature of approximately 150 degree C.

12. The method of claim 10, wherein during the cooling step, the second plastic material and the lubricating material are cooled to approximately 20 degree C.

13. The method of claim 10, wherein the lubricating material is selected from the group consisting of fatty amides, hydrocarbon oils, plasticizers, silicone oils and mixtures thereof.

14. The method of claim 13, wherein the lubricating material comprises oleamide.

15. The method of claim 13, wherein the lubricating material comprises erucamide.

16. The method of claim 13, wherein the lubricating material comprises mineral oil.

17. The method of claim 13, wherein the lubricating material comprises silicone oil.

18. The method of claim 13, wherein the lubricating material comprises dibasic esters.

19. The method of claim 13, wherein the lubricating material comprises ethylenebisstearamide.

20. The method of claim 13, wherein the first plastic material is polyvinylchloride.

21. The method of claim 13, wherein the second plastic material is a polyamide.
